(19) United States
(12) Patent Application Publication
(10) Pub. No.: US 2025/0094686 A1
(43) Pub. Date: Mar. 20, 2025

(54) NARRATIVE POINT OF VIEW MODIFICATION FOR CONTENT GENERATED BY A MACHINE-LEARNED MODEL

(71) Applicant: Oracle International Corporation, Redwood Shores, CA (US)

(72) Inventors: Zheng Wang, Sammamish, WA (US); Yazhe Hu, Bellevue, WA (US); Mengqing Guo, Redmond, WA (US); Tao Sheng, Bellevue, WA (US); Jun Qian, Bellevue, WA (US); Vinod Murli Mamtani, Bellevue, WA (US)

(21) Appl. No.: 18/758,321

(22) Filed: Jun. 28, 2024

Related U.S. Application Data
(60) Provisional application No. 63/583,246, filed on Sep. 16, 2023.

(51) Int. Cl. G06F 40/166; G06F 40/279

(52) U.S. Cl. CPC G06F 40/166; G06F 40/279

(57) ABSTRACT

Techniques for modifying a narrative point of view for content generated by a machine-learned model, such as a large language model (LLM), are provided. In one technique, a first textual content that was generated by an LLM is accessed. A narrative point of view (NPOV) detection operation is performed on a first portion of the first textual content to identify a first NPOV corresponding to the first portion of the first textual content. Based on an output, of the NPOV detection operation, that indicates that the first NPOV does not meet one or more NPOV criteria, the first portion of the first textual content is modified to generate a modified textual content. The modified textual content is submitted to the LLM, causing the LLM to generate a second textual content.

### BENEFIT CLAIM

This application claims benefit under 35 U.S.C. § 119(e) of provisional application 63/583,246, filed Sep. 16, 2023, by Zheng Wang et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### TECHNICAL FIELD

The present disclosure relates to modifying narrative point of view in content that was generated by a large language model (LLM). In particular, the present disclosure relates to iteratively identifying and modifying narrative point of view anomalies in LLM-generated content, and resubmitting modified content to the LLM to remediate the point-of-view anomalies.

### BACKGROUND

Large language models (LLMs) are a type of deep learning model that combines a deep learning technique called attention in combination with a deep learning model type known as transformers to build predictive models. These predictive models encode and predict natural language writing. LLMs contain hundreds of billions of parameters trained on multiple terabytes of text. LLMs are trained to receive natural language as an input. Consequently, LLMs are extremely useful for generating natural-language answers to questions formulated in natural language. Since LLMs are trained on terabytes of text of many different types, including journals, articles, websites, and books, LLMs may not necessarily generate textual content that adheres to a desired set of grammatical rules. For example, content generated by LLMs frequently switches between a first-person narrative point of view and a third-person narrative point of view.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 is a block diagram that depicts an example narrative point-of-view (NPOV) correction system, in an embodiment;

FIG. 2 is a flow diagram that depicts an example process for modifying a narrative point of view in LLM-generated content, in an embodiment;

FIG. 3 depicts an example set of operations for iteratively modifying NPOV content in LLM-generated content, in an embodiment;

FIG. 4 is a block diagram that illustrates a computer system upon which an embodiment of the invention may be implemented;

FIG. 5 is a block diagram of a basic software system that may be employed for controlling the operation of the computer system.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### General Overview

A system and method for executing an iterative process for generation of content that maintains a target and/or consistent narrative point of view are provided. In one technique, the system/method iteratively (a) evaluates and modifies content generated by an LLM and (b) resubmits the modified content to the LLM to trigger generation of updated content until the LLM generates updated content that maintains a target and/or consistent narrative point of view.

Initially, the technique applies a set of one or more narrative point of view (NPOV) operations (e.g., one or more detection rules or a language model) on LLM-generated content in order to detect a NPOV associated with various portions of the content. The detected NPOV is evaluated against one or more NPOV criteria. Evaluating the detected NPOV may include checking for a consistent NPOV across the various portions of the content. Alternatively, or additionally, evaluating the detected NPOV may include checking whether the NPOV, detected across various portions of the content, matches a target NPOV.

If the detected NPOV does not meet the one or more NPOV criteria, then the technique modifies the content to generate modified content that meets the one or more NPOV criteria. However, the modified content may lack clarity, may include incomplete sentences, may include grammatical errors, or may otherwise be unsuitable for transmission to a requesting entity. As an example, the technique may modify the content by simply deleting portions with a NPOV that does not meet the one or more NPOV criteria.

Thereafter, the technique submits the modified content to the LLM. The submission of the modified content results in an updated content being generated by the LLM. The technique may iteratively repeat the evaluation, modification, and resubmission process with the updated content until the LLM generates updated content that meets the one or more NPOV criteria. Once LLM-generated updated content with a NPOV that meets the one or more NPOV criteria is detected, the technique transmits the LLM-generated updated content to a requesting entity.

Embodiments improve computer-related technology by improving LLM-generated content.

### Example System

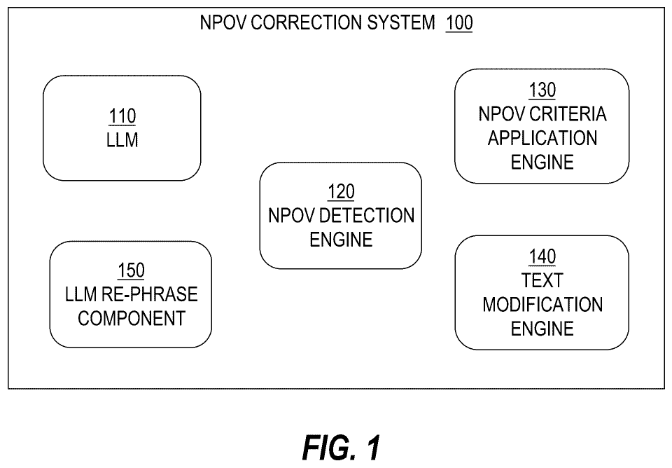

FIG. 1 is a block diagram that depicts an example narrative point-of-view (NPOV) correction system 100, in an embodiment. NPOV correction system 100 includes an LLM 110, a narrative point-of-view (NPOV) detection engine 120, a NPOV criteria application engine 130, a text modification engine 140, and a re-phrase component 150. Each of LLM 110, narrative point-of-view (NPOV) detection engine 120, NPOV criteria application engine 130, text modification engine 140, and re-phrase component 150 may be implemented in software, hardware, or any combination of software and hardware. NPOV correction system 100 may be communicatively connected to one or more user devices (not depicted).

In an embodiment, NPOV correction system 100 includes more or fewer components than the components described above. The components may be local to or remote from each other. Each component may be distributed over multiple applications and/or machines. Multiple components may be combined into one application and/or machine. Operations described with respect to one component may instead be performed by another component.

In an embodiment, NPOV correction system 100 is implemented on one or more digital devices. The term “digital device” generally refers to any hardware device that includes one or more processors. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

A user accesses LLM 110 via NPOV correction system 100. For example, a user may specify a natural language prompt or query in a web page displayed in a web browser executing on the user's device. The user device transmits the user-generated query to NPOV correction system 100. NPOV correction system 100 provides the prompt/query to LLM 110. In response to the prompt/query, LLM 110 generates content, such as textual content and/or image content that may include textual content. Typically, the textual content is natural-language text content, or content presented in a grammatical structure of readable and coherent sentences and paragraphs.

### NPOV Detection Engine

NPOV detection engine 120 receives content from LLM 110. NPOV detection engine 120 analyzes the content to detect or identify one or more narrative point-of-views presented in a portion of the LLM-generated content or the entirety of textual content within the originally-generated content.

In an embodiment, NPOV detection engine 120 applies a set of rules to detect one or more NPOVs in the LLM-generated content. The set of rules may specify, for example, that phrases and sentences including pronouns “he,” “she,” and “it” are written in a third-person POV. The set of rules may specify that phrases and sentences including pronouns “we” and “I” are written in a first-person POV. The set of rules may specify that phrases and sentences including the pronoun “you” are written in a second-person POV. In addition, the detection rules may specify that the use of proper names indicates a third-person POV. In addition, the detection rules may specify that certain verb conjugations correspond to certain NPOVs. For example, “walks” corresponds to a third-person POV, but not to first-person or second-person POVs.

In an embodiment, NPOV detection engine 120 includes a detection language model that, given a portion of the LLM-generated content, identifies one or more NPOVs in that portion. The detection language model is trained to identify a NPOV of a set of text, such as a sentence. The detection language model may be trained to output, given a portion of the LLM-generated content as input, a classification of a NPOV (e.g., first-person, second-person, third-person) or a “mixed POV” classification, when a particular phrase or sentence combines two or more POVs, such as a first-person POV and a third-person POV.

In an embodiment, NPOV detection engine 120 includes a set of rules and a detection language model. Thus, given the LLM-generated content, NPOV detection engine 120 applies the set of rules to the LLM-generated content and invokes the detection language model, passing in the LLM-generated content as input. In this way, it is more likely that all NPOVs in the LLM-generated content are detected.

### Rule-Based and Model-Based Detection

In an embodiment, NPOV detection engine 120 applies the set of rules on the LLM-generated content (or a portion thereof) first and then determines whether to invoke the detection language model (e.g., for that portion). If NPOV detection engine 120 determines to not invoke the detection language model, then computer resources are preserved (at least with respect to that portion), since invoking the detection language model (and having the detection language model generate output) requires more computer resources (e.g., memory, CPU, network bandwidth) than applying the set of rules.

The determination of whether to use the detection language model may be based on output from applying the set of rules. For example, if the LLM-generated content comprises multiple sentences and the set of rules is applied to each sentence, an output corresponding to each sentence may be an NPOV identification and/or a score, such as a confidence score that indicates how confident that application of the set of rules to the sentence resulted in a positive NPOV identification for that sentence. If a result of the application of the set of rules to a sentence indicates that an NPOV identification was not made, then NPOV detection engine 120 invokes the detection language model for that sentence. Therefore, NPOV detection engine 120 might not invoke the detection language model for one or more sentences in the LLM-generated content. In some cases, NPOV detection engine 120 might not use the detection language model at all, just the set of rules.

### Machine Learning Algorithm

In an embodiment, one or more elements of the detection language model use a first machine learning algorithm to identify a narrative POV for a block of text. In addition, one or more other elements of the POV detection-type machine-learned model may use a second machine learning algorithm to modify a narrative POV for a block of text. A machine learning algorithm is an algorithm that can be iterated to learn a target model f that best maps a set of input variables to an output variable, using a set of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In an embodiment, a set of training data includes datasets and associated labels. The datasets are associated with input variables (e.g., a set of text content) for the target model f. The associated labels are associated with the output variable (e.g., POV labels associated with the set of textual content) of the target model f. The training data may be updated based on, for example, feedback on the accuracy of the current target model f. Updated training data is fed back into the machine learning algorithm, which in turn updates the target model f.

A machine learning algorithm generates a target model f, such that the target model f best fits the datasets of training data to the labels of the training data. Additionally, or alternatively, a machine learning algorithm generates a target model f, such that when the target model f is applied to the datasets of the training data, a maximum number of results determined by the target model f matches the labels of the training data.

### NPOV Criteria Application Engine

Based on the narrative POVs identified in the LLM-generated content, NPOV criteria application engine 130 determines whether the LLM-generated content (or a portion thereof) meets a set of one or more NPOV criteria. There may be a single NPOV criterion or multiple NPOV criteria. If the set of NPOV criteria is met, then system 100 stores the LLM-generated content and/or provides the LLM-generated content as a response to a requesting entity.

In an embodiment, the set of NPOV criteria specifies that all the textual content is presented in the same NPOV. For example, all the textual content is presented in a first-person NPOV, a second-person NPOV, or a third-person NPOV. If output from NPOV detection engine 120 indicates that NPOVs detected in the LLM-generated content are in the same NPOV indicated in the set of NPOV criteria, then the set of NPOV criteria is met; otherwise, the set of NPOV criteria is not met.

In a related embodiment, the set of NPOV criteria specifies that all the text content is to be presented in a particular NPOV. For example, a set of text may be presented in a third-person NPOV, but the NPOV criteria may specify that the text should be presented in a first-person NPOV from the perspective of one character in the text which includes multiple characters. In this example, the set of text does not satisfy the set of NPOV criteria.

The set of NPOV criteria may be a default value that is stored in a configuration file that is accessible to NPOV criteria application engine 130. Alternatively, the set of NPOV criteria may be specified by a user (e.g., the same user that specified the prompt that system 100 receives) or by an administrator of system 100. In an embodiment, the set of NPOV criteria changes from time to time, including from prompt to prompt.

### Text Modification Engine

If NPOV criteria application engine 130 determines that the LLM-generated content (or a portion thereof) does not meet the set of NPOV criteria, then text modification engine 140 performs one or more modifications to the textual content, resulting in modified textual content.

In an embodiment, text modification engine 140 includes a rule-based modification engine or a modification language model, or both. The rule-based modification engine applies a set of rules to the text content to modify one or more NPOV terms according to the NPOV criteria. For example, if a sentence includes the proper name “Roger” and a pronoun “she,” and if the NPOV criteria specify that the text content should be written in a first-person NPOV from the perspective of “Roger,” then the rule-based modification engine may modify the name “Roger” to “I.” The resulting sentence may or may not be grammatically correct. For example, the rules may or may not modify verb conjugations based on an NPOV. In addition, if a sentence includes multiple pronouns, such as “he,” then the rule-based modification engine may not be equipped to identify which pronouns correspond to which characters.

Text modification engine 140 may apply a modification language model to the originally-generated content or to the modified textual content according to the NPOV criteria. For example, text modification engine 140 applies the modification language model to portions of the modified textual content that the rule-based modification engine could not entirely modify based on the NPOV criteria.

In an embodiment, text modification engine 140 provides modified textual content to LLM 110 to rephrase the modified textual content according to the NPOV criteria. In this example, text modification engine 140 may generate one or more tags or prompts to indicate, to LLM 110, that a new set of textual content should be generated, based on the initial set of textual content, but satisfying particular POV criteria. For example, text modification engine 140 tags particular words (e.g., pronouns, proper names, and verbs) that the system has identified as requiring modification.

In a related embodiment, a tag includes a gender indicator to indicate to which gender a modified narrative POV should correspond. For example, the system tags an “I” pronoun with a first tag indicating the pronoun should be changed, and a “male” gender indicator, indicating the pronoun should be changed to a third-person male NPOV.

In an embodiment, text modification engine 140 does not modify the words existing in a set of text content. Instead, text modification engine 140 may (a) identify words (e.g., pronouns, proper nouns, and verbs) that require modification to meet NPOV criteria, and (b) mark or tag the words for LLM 110 in order to identify, for LLM 110, the words that may require modification.

If the subsequent textual content generated by LLM 110 meets the NPOV criteria, then the subsequent textual content is transmitted to a requesting entity (e.g., from which the triggering request originated). If the subsequent textual content does not meet the NPOV criteria, then the components of system 100 iteratively detects and modifies the subsequent textual content according to the NPOV criteria and resubmits the modified text content to LLM 110.

### Example Process

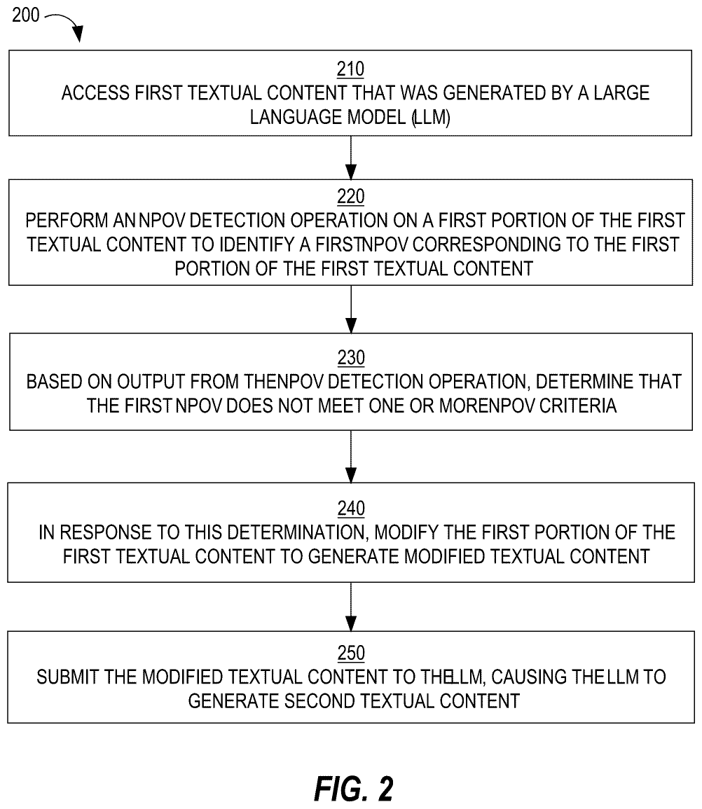

FIG. 2 is a flow diagram that depicts an example process 200 for modifying a narrative point of view in LLM-generated content, in an embodiment. Different components of system 100 may perform different parts of process 200.

At block 210, first textual content that was generated by a large language model (LLM) is accessed. Block 210 may be performed immediately after the first textual content is generated, or some time later. Thus, the first textual content may have been generated in volatile memory and accessed directly from that volatile memory. Alternatively, the first textual content may be stored to non-volatile memory after generation. Later, the first textual content is retrieved from non-volatile memory, such as disk storage, and stored in volatile memory from which the first textual content is accessed. Block 210 may be performed by NPOV detection engine 120.

At block 220, an NPOV detection operation is performed on a first portion of the first textual content to identify a first NPOV corresponding to the first portion of the first textual content. Block 220 may be performed by NPOV detection engine 120. The NPOV detection operation may involve applying one or more detection rules on the first portion, invoking a detection language model on the first portion, or both.

At block 230, based on output from the NPOV detection operation, it is determined that the first NPOV does not meet one or more NPOV criteria. The one or more NPOV criteria may comprise a target NPOV or may be a requirement that the NPOV is consistent throughout the first textual content.

At block 240, in response to this determination, the first portion of the first textual content is modified to generate modified textual content. Block 240 may be a removal of one or more words from the first portion and/or a change of one or more words in the first portion.

At block 250, the modified textual content is submitted to the LLM, causing the LLM to generate a second textual content. Block 250 may include generating a prompt that requests the LLM to re-phrase the modified textual content. Process 200 may then repeat but with the second textual content replacing the first textual content.

### Iterative Modification of POV Content in LLM-Generated Content

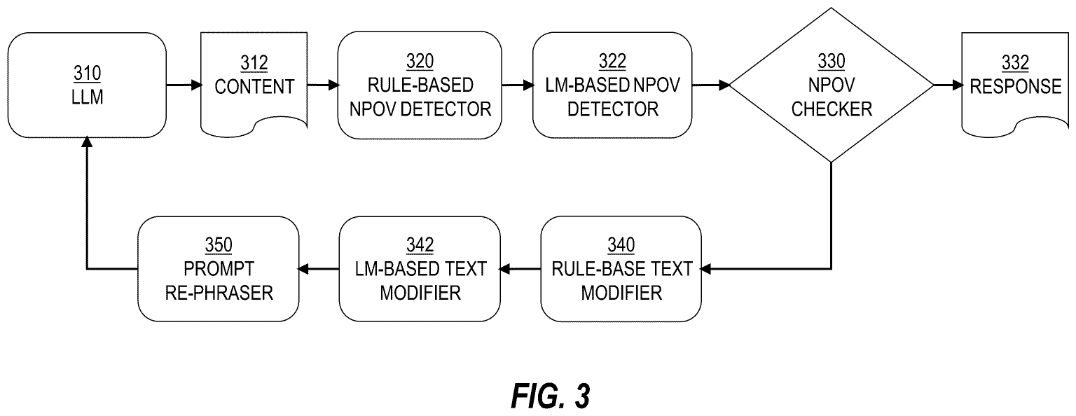

FIG. 3 depicts an example set of operations for iteratively modifying NPOV content in LLM-generated content, in an embodiment. One or more operations illustrated in FIG. 3 may be modified, rearranged, or omitted all together. Accordingly, the particular sequence of operations depicted in FIG. 3 should not be construed as limiting the scope of the embodiment.

LLM 310 generates content 312 in response to a prompt or query. For example, a user or application may provide a set of natural language content, such as a question or statement, to LLM 310.

Rule-based NPOV detector 320 applies a set of NPOV detection rules to content 312 to determine narrative POV characteristics of content 312. For example, a set of POV detection rules may identify pronouns (e.g., I, we, they, you, he, she, it) associated with first-, second-, and third-person points of view in portions of text. In addition, the NPOV detection rules may specify that the use of proper names indicates a third-person narrative POV. In addition, the detection rules may specify that certain verb conjugations correspond to certain narrative POVs.

In an embodiment, rule-based NPOV detector 320 divides content 312 into grammatical elements, such as phrases, sentences, and paragraphs. Rule-based NPOV detector 320 applies the NPOV detection rules to the phrases, sentences, and paragraphs to identify a point of view for the phrases, sentences, and paragraphs.

In an embodiment, it is determined whether rule-based NPOV detector 320 was able to determine the point of view of content 312 using the detection rules alone. For example, a percentage of phrases in which a NPOV has been identified is compared to a threshold percentage. Similarly, a percentage of sentences in which a NPOV has been identified may be compared to a threshold percentage. For example, while phrases and sentences including pronouns and proper nouns tend to indicate a particular NPOV, phrases and sentences that are merely descriptive, are written in a passive voice, or are written in a command voice and, therefore, may be more difficult to classify. In addition, the use of different pronouns within a phrase or sentence may make rule-based POV detection difficult. In addition, the use of quotes, indicating spoken words which would not change a narrative POV of the text, may make rule-based POV detection difficult.

If the NPOV of content 312 using the set of rules is difficult to determine, then a language model-based NPOV detector 322 is used to determine the NPOV for one or more portions of content 312. For example, it may be determined that a certain number of phrases lack pronouns indicating n NPOV. If that number of phrases exceeds a threshold, then language model-based NPOV detector 322 is invoked and content 312 is included as input to the invocation. Similarly, it may be determined that an NPOV cannot be determined for a number of sentences in content 312. If that number of sentences exceeds a threshold, then language model-based NPOV detector 322 is invoked.

Based on one or both of rule-based NPOV detector 320 and language model-based NPOV detector 322, NPOV checker 330 determines whether content 312 meets one or more NPOV criteria. If so, then a response 332 is generated based on content 312 and transmitted to a requesting device or application.

Otherwise, a rule-based text modifier 340 modifies content 312 according to the NPOV criteria. For example, if a sentence includes a first-person narrative POV with the pronoun “I”, and if the NPOV criteria specify that the text content should be in the third-person POV, then rule-based text modifier 340 applies a set of rules to change instances of the pronoun “I” to “they.” For example, a sentence: “I am the one who prepared the document” may be modified with the rule-based modification to “They am the one who prepared the document.” In an embodiment, rule-based text modifier 340 further includes modifying verb conjugations. For example, the sentence “I am the one who prepared the document” may be modified to “They are the one who prepared the document.”

In an embodiment, subsequent to invoking rule-based text modifier 340, a language model-based text modifier 342 is invoked with respect to the modified text content to further modify content 312 according to the NPOV criteria. For example, applying one or more modification rules to a first set of text in content 312 causes first modified content to be generated. However, it is determined that other portions of content 312 (e.g., other sentences in content 312), were (or could) not be modified by the set of rules. Thus, language model-based text modifier 342 is invoked with respect to a second set of text in content 312 to generate a second modified content.

As one example, a set of text may include (a) proper names, including a name “Alexander”, (b) “he” pronouns, and (c) “she” pronouns. The NPOV criteria may specify a first-person point of view from the view of the character “Alexander.” Language model-based text modifier 342 may apply a clustering-type neural network to cluster pronouns and proper names that refer to the same individuals. For example, one set of “he” pronouns may correspond to the character “Alexander,” another set of “he” pronouns may correspond to a character “Bill,” and the “she” pronouns may correspond to a character “Beatrice.” The clustering-type neural network may identify the name “Alexander” and corresponding set of “he” pronouns as requiring modification according to the NPOV criteria. The clustering-type neural network may identify the “he” pronouns associated with the character “Bill” as not requiring modification based on the NPOV criteria.

In an embodiment, modifying content 312 includes generating one or more tags or prompts to indicate to LLM 310 that a new set of text content should be generated, based on the initial set of text content, but satisfying particular NPOV criteria. For example, text modifier 340 and/or 342 tags particular words (e.g., pronouns, proper names, and verbs) that text modifier 340 and/or 342 has identified as requiring modification. A tag may include a gender indicator to indicate to which gender a modified narrative POV should correspond. For example, text modifier 340/342 tags an “I” pronoun with a first tag indicating the pronoun should be changed, and a “male” gender indicator, indicating the pronoun should be changed to a third-person male NPOV.

While an embodiment is described above in which a rule-based modification process and a language model-based modification process are performed prior to providing modified text content to LLM 310, in an alternative embodiment, the rule-based and language model-based modification processes do not modify the content of the text. Instead, these processes may (a) identify words (e.g., such as pronouns, proper nouns, and verbs) that require modification to meet NPOV criteria, and (b) mark or tag the words for LLM 310 to identify, for LLM 310, the words requiring modification.

Prompt re-phraser 350 provides the modified text content back to LLM 310 with a prompt to direct LLM 310 to rephrase the text content according to the NPOV criteria. For example, the modified text may be natural language text with pronouns, proper names, and/or verbs modified based on NPOV criteria. In an embodiment, the modifications result in modified text content that might be grammatically incorrect. In a related embodiment, the modifications correspond to tagging or marking pronouns, names, and/or verbs with tags indicating (a) tokens that should be changed by LLM 310, and (b) the NPOV criteria that LLM 310 should apply in the next iteration of text content generated by LLM 310.

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

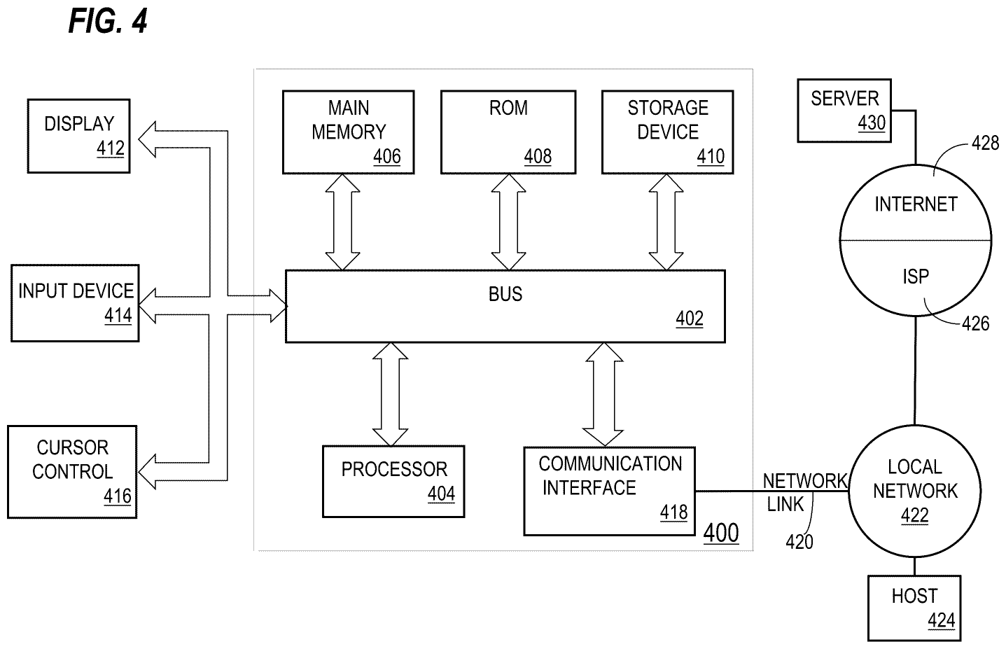

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

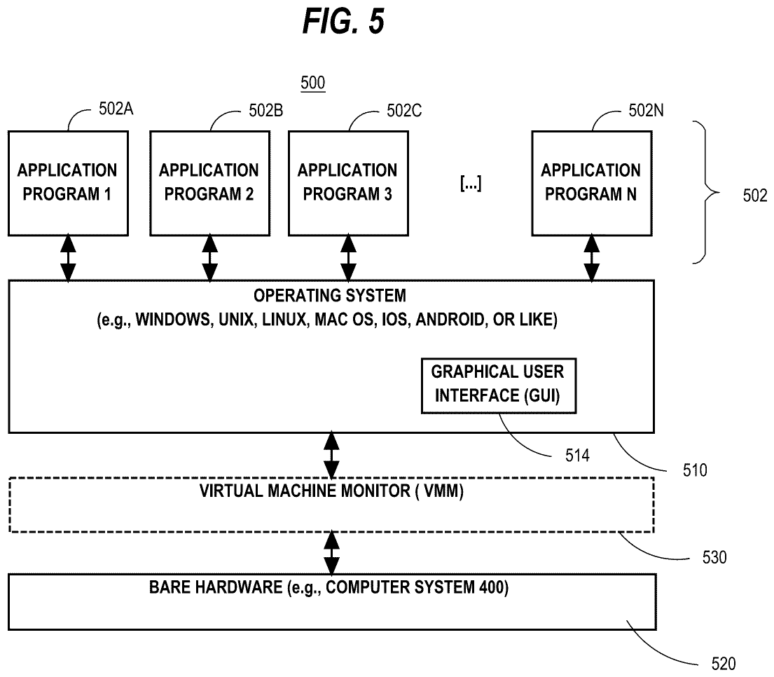

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
accessing a first textual content that was generated by a large language model (LLM);
performing a narrative point of view (NPOV) detection operation on a first portion of the first textual content to identify a first NPOV corresponding to the first portion of the first textual content;
based on an output, of the NPOV detection operation, that indicates that the first NPOV does not meet one or more NPOV criteria, modifying the first portion of the first textual content to generate a modified textual content;
submitting the modified textual content to the LLM, causing the LLM to generate a second textual content;
wherein the method is performed by one or more computing devices.

2. The method of claim 1, wherein modifying the first portion of the first textual content comprises at least one of:
replacing a first word corresponding to the first NPOV with a second word corresponding to a second NPOV; or
deleting the first word corresponding to the first NPOV.

3. The method of claim 1, wherein the one or more NPOV criteria requires consistency across each NPOV corresponding to each portion of the first textual content, and wherein determining that the NPOV, corresponding to the first portion of the first textual content, does not meet the one or more NPOV criteria comprises:
determining that the first NPOV, corresponding to the first portion of the first textual content, is different than a third NPOV corresponding to a second portion of the first textual content.

4. The method of claim 1, wherein the one or more NPOV criteria requires that each NPOV corresponding to each portion of the first textual content matches a target NPOV, wherein determining that the first NPOV, corresponding to the first portion of the first textual content, does not meet the one or more NPOV criteria comprises:
determining that the first NPOV, corresponding to the first portion of the first textual content, is different than the target NPOV.

5. The method of claim 1, further comprising:
determining that a second NPOV in the second textual content meets the one or more NPOV criteria; and
in response to determining the second NPOV in the second textual content meets the one or more NPOV criteria, transmitting the second textual content to a requesting entity.

6. The method of claim 1, further comprising:
prior to accessing the first textual content:
accessing a third textual content generated by the LLM;
identifying a third NPOV corresponding to a second portion of the third textual content;
in response to determining the third NPOV does not meet the one or more NPOV, modifying the second portion of the third textual content to generate a second modified textual content; and
submitting the second modified textual content to the LLM, wherein the LLM generates the first textual content based on submission of the second modified textual content to the LLM.

7. The method of claim 1, wherein:
the NPOV detection operation involves applying a set of NPOV detection rules to the first textual content to identify the first NPOV;
the method further comprising, in response to determining that the first NPOV has been identified by applying the set of NPOV detection rules, refraining from applying a language recognition model to the first textual content for identifying the first NPOV.

8. The method claim 1, wherein:
the NPOV detection operation involves applying a set of NPOV detection rules to the first textual content to identify the first NPOV;
the method further comprising, in response to determining that the first NPOV has not been identified by applying the set of NPOV detection rules, applying a language recognition model to the first textual content to identify the first NPOV.

9. The method of claim 1, further comprising:
iteratively modifying sets of textual content to generate corresponding sets of modified textual content, and applying the LLM to the sets of modified textual content until the one or more NPOV are met.

10. The method of claim 1, wherein modifying the first portion of the first textual content to generate the modified textual content is performed by at least one of:
applying a set of rule-based narrative conversion operations; or
applying a language model-based narrative conversion operation.

11. The method of claim 1, further comprising:
prior to accessing the first textual content:
receiving a user request from a client device;
generating a first prompt based on the user request; and
submitting the first prompt to the LLM to obtain the first textual content; and
after determining that the second textual content meets the one or more NPOV criteria, forwarding the second textual content to the client device.

12. One or more non-transitory storage media storing instructions which, when executed by one or more computing devices, cause:
accessing a first textual content that was generated by a large language model (LLM);
performing a narrative point of view (NPOV) detection operation on a first portion of the first textual content to identify a first NPOV corresponding to the first portion of the first textual content;
based on an output, of the NPOV detection operation, that indicates that the first NPOV does not meet one or more NPOV criteria, modifying the first portion of the first textual content to generate a modified textual content;
submitting the modified textual content to the LLM, causing the LLM to generate a second textual content.

13. The one or more storage media of claim 12, wherein modifying the first portion of the first textual content comprises at least one of:
replacing a first word corresponding to the first NPOV with a second word corresponding to a second NPOV; or
deleting the first word corresponding to the first NPOV.

14. The one or more storage media of claim 12, wherein the one or more NPOV criteria requires consistency across each NPOV corresponding to each portion of the first textual content, and wherein determining that the NPOV, corresponding to the first portion of the first textual content, does not meet the one or more NPOV criteria comprises:
determining that the first NPOV, corresponding to the first portion of the first textual content, is different than a third NPOV corresponding to a second portion of the first textual content.

15. The one or more storage media of claim 12, wherein the one or more NPOV criteria requires that each NPOV corresponding to each portion of the first textual content matches a target NPOV, wherein determining that the first NPOV, corresponding to the first portion of the first textual content, does not meet the one or more NPOV criteria comprises:
determining that the first NPOV, corresponding to the first portion of the first textual content, is different than the target NPOV.

16. The one or more storage media of claim 12, wherein the instructions, when executed by the one or more computing devices, further causes:
determining that a second NPOV in the second textual content meets the one or more NPOV criteria; and
in response to determining the second NPOV in the second textual content meets the one or more NPOV criteria, transmitting the second textual content to a requesting entity.

17. The one or more storage media of claim 12, wherein the instructions, when executed by the one or more computing devices, further causes:
prior to accessing the first textual content:
accessing a third textual content generated by the LLM;
identifying a third NPOV corresponding to a second portion of the third textual content;
in response to determining the third NPOV does not meet the one or more NPOV, modifying the second portion of the third textual content to generate a second modified textual content; and
submitting the second modified textual content to the LLM, wherein the LLM generates the first textual content based on submission of the second modified textual content to the LLM.

18. The one or more storage media of claim 12, wherein:
the NPOV detection operation involves applying a set of NPOV detection rules to the first textual content to identify the first NPOV;
wherein the instructions, when executed by the one or more computing devices, further causes, in response to determining that the first NPOV has been identified by applying the set of NPOV detection rules, refraining from applying a language recognition model to the first textual content for identifying the first NPOV.

19. The one or more storage media of claim 12, wherein:
the NPOV detection operation involves applying a set of NPOV detection rules to the first textual content to identify the first NPOV;
wherein the instructions, when executed by the one or more computing devices, further causes, in response to determining that the first NPOV has not been identified by applying the set of NPOV detection rules, applying a language recognition model to the first textual content to identify the first NPOV.

20. The one or more storage media of claim 12, wherein modifying the first portion of the first textual content to generate the modified textual content is performed by at least one of:
applying a set of rule-based narrative conversion operations; or
applying a language model-based narrative conversion operation.
